(19) United States
(12) Patent Application Publication
(10) Pub. No.: US 2012/0247281 A1
(43) Pub. Date: Oct. 4, 2012

(54) Ratcheting Wrench

(75) Inventor: Tomas Foltyn, Abbotsford (CA)

(73) Assignee: Tomas Foltyn, Abbotsford (CA)

(21) Appl. No.: 13/171,452

(22) Filed: Jun. 29, 2011

Related U.S. Application Data
(60) Provisional application No. 61/360,422, filed on Jun. 30, 2010.

(51) Int. Cl. B25B 13/46; B25B 13/50

(52) U.S. Cl. 81/177.8; 81/52; 81/179; 81/177.1; 81/177.2

(57) ABSTRACT

An open ended, adjustable, ratcheting wrench comprising an extendable handle, a fixed upper jaw attached to the handle and a moveable lower jaw containing a sliding protrusion. One of the upper jaws and the lower jaw has a generally V-shaped recess. The other of the upper or lower jaws contains the sliding protrusion aligned with a center line of the V-shaped recess.

### FIELD OF THE INVENTION

This invention relates to hand tools. Particular embodiments of the invention provide hand tools for turning fittings such as nuts, bolts, flare nuts including specialty and security fasteners. The invention may be embodied, for example, in an open ended style, adjustable, ratcheting wrench configuration.

The invention relates to ratchet wrenches, including ratchet wrenches that are open-ended and/or adjustable to engage workpieces with different sizes.

### BACKGROUND

Open ended wrenches are often used by tradespeople because a quality open ended wrench that has tight tolerances makes for a perfect fit when it comes to tightening or loosening fasteners. Fixed wrenches do not become more difficult to operate if they become dirty or gritty as adjustable wrenches do. Fixed wrenches are also more compact in overall appearance and design which allows them to perform better in tighter work spaces.

The most popular type of open ended wrench contacts the fitting on only two surfaces. One disadvantage of this design is that the wrench contacts only two sides of a fitting typically the opposite faces. Often this design has a tendency to round off the edges of a fitting especially if softer alloy fittings such as copper, aluminum, brass when greater torque is required to either tighten or loosen a fitting. Once a fitting has been “rounded off”, it can also become out of round and is considered damaged goods. If this fitting happens to be a flare nut on the end of a fuel line or hydraulic fitting, this can account for further costs and additional man hours to replace. Also, a rounded fitting can cause personal injury to the tradesperson if slippage occurs suddenly.

Adjustable wrenches or spanners are another tool often used by tradespeople to turn fittings. Open ended wrenches are designed to fit a specific fitting or fastener. They normally require that the wrench be placed onto a fastener, turned, then lifted off of the fastener, repositioned and turned once again. The embodiment of this invention allows for a secure, slip-resistant placement of the wrench onto a fastener and the ability to turn the fastener and reposition the handle of the wrench back to its starting position without removing wrench head from the fastener. Occasionally, a product manufacturer may wish to use specialized security fasteners to deter others from tampering with a piece of equipment, however, a tradesperson with the proper tools and equipment knowledge can remove those types of fasteners quickly and easily.

Several types of open ended adjustable ratcheting wrenches are known. Some examples are:

Publication Number: US20090193939

Patent Number: U.S. Pat. No. 5,297,459

Patent Number: U.S. Pat. No. 3,926,077

Patent Number: U.S. Pat. No. 5,890,404

Patent Number: U.S. Pat. No. 5,018,412

Patent Number: U.S. Pat. No. 7,275,464

Patent Number: U.S. Pat. No. 6,679,139

Patent Number: U.S. Pat. No. 6,530,298

Patent Number: U.S. D0463233

Patent Number: U.S. Pat. No. 7,059,221

The inventor has identified a need for hand tools that address these issues associated with typical wrenches that are currently available today.

### SUMMARY

The following embodiments and aspects thereof are described and illustrated in conjunction with systems, tools, and methods which are meant to be exemplary and illustrative, not limiting in scope. In various embodiments, one or more of the above described challenges have been overcome, reduced or eliminated, while other embodiments are directed to other improvements.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a wrench according to one embodiment of the invention.

FIG. 2 shows an open ended adjustable ratcheting wrench of FIG. 1 with outer portion of its lower jaw extended away from the handle allowing the fitting to slip and reposition the handle of the wrench.

FIG. 3 shows an open ended adjustable ratcheting wrench of FIG. 1 gripping a security fastener between its jaws.

FIG. 4 shows an open ended adjustable ratcheting wrench with nut N held between the outer portions of the wrenches jaws.

FIG. 5 shows an open ended adjustable ratcheting wrench of FIG. 1 gripping a security fastener between its jaws with the handle portion extended for more leverage.

FIG. 6 shows an open ended adjustable ratcheting wrench of FIG. 1 gripping a security fastener between its jaws with the handle portion extended for more leverage.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

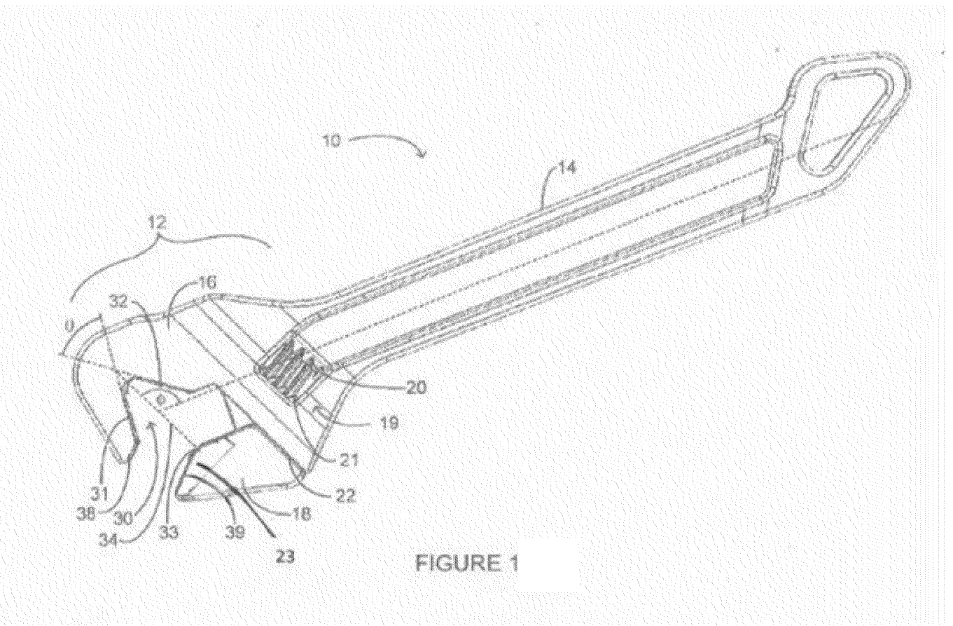

FIG. 1 shows an open ended adjustable ratcheting type wrench 10 according to a specific embodiment to the invention. Wrench 10 has a head 12 attached to a handle 14.

Upper jaw 16 is characterized by a V-shaped recess 30 defined in its side facing toward the lower jaw 18. Recess 30 has opposite sides 31 and 32 that are disposed at an angle 0 to one another. Angle 0 is typically in the range of 55-65 degrees and is preferably approximately 60 degrees.

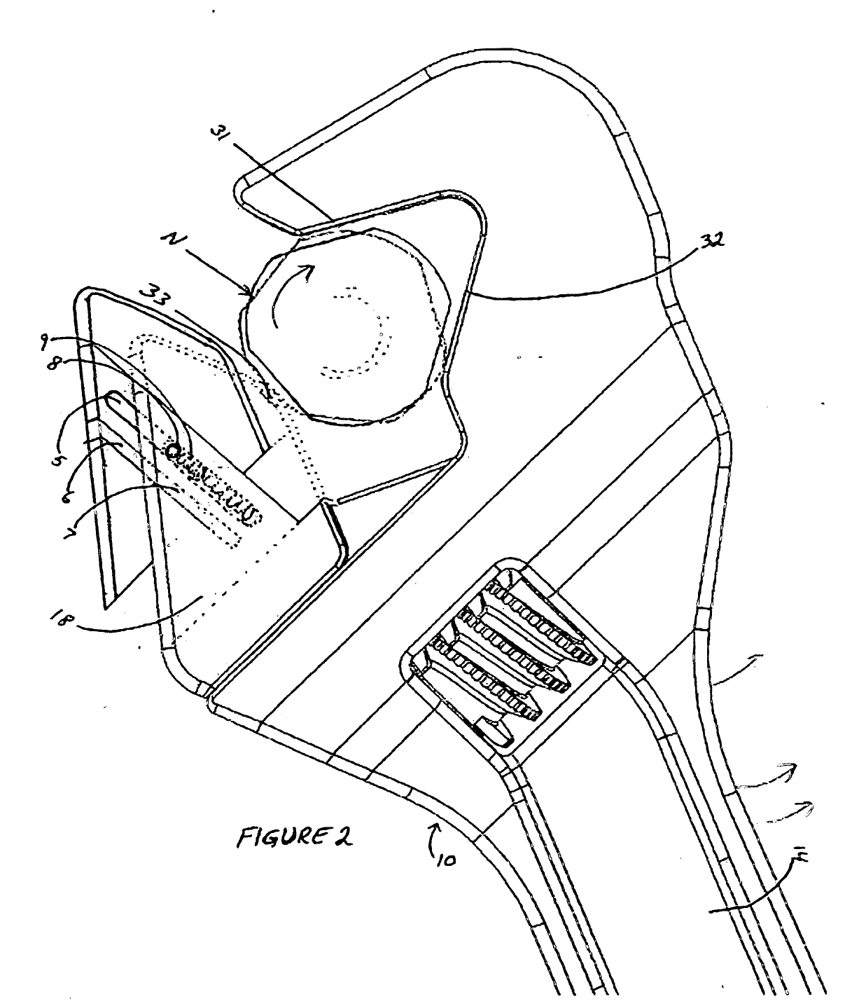

Movable lower jaw 18 has a slidable projection 23 on the lower jaw which is aligned with a centerline 34 of recess 30. In the embodiment illustrated in FIG. 1, the slidable projection 23 of movable lower jaw 18 can slide or pivot away from handle 14 thereby allowing security fastener nut N to pass by the slidable projection 23 on the movable lower jaw 18 as illustrated in FIG. 2. As the handle 14 is pulled towards the wrench head, of movable jaw 18 away from the handle 14 thereby creating the space required in order for edges of nut N to slip past the projection 33 in order to reposition the contact surfaces 31, 32 and 33 of wrench 10 onto the flat surfaces of security fastener nut N in order to turn nut N once again. As the handle 14 is pulled towards the wrench head, the slidable projection 33 of movable jaw 18 the edges of nut N force the slidable projection 33 to protrude out of lower jaw 18 away from the movable lower jaw thereby compressing spring 9 in the spring housing by the spring pin 8. As wrench 10 is repositioned on the flat surfaces of Security fastener nut N thereby decompressing spring 9 wherein the guide 5 of slidable projection 33 slides along the guide 7 of the lower jaw and returns to its original position back in to the receiving chamber of lower jaw 18. As the handle 14 of wrench 10 is pulled towards the lower jaw 18, slidable protrusion 33 binds against lower jaw 18 to turn security fastener nut N once the flat surfaces of security nut N is placed securely within the contact points 31, 32 and 33 of wrench 10.

In the embodiment illustrated in FIG. 1, centerline 34 of V-shaped indentation 30 makes an angle O with the center line of handle 14. The particular angle O may be selected to have any value in a wide range. In the illustrated embodiment O is approximately 105 degrees. This gives wrench 10 an offset of 15 degrees. However, wrenches could readily be made for which angle O is anywhere in the range of 0-180 degrees.

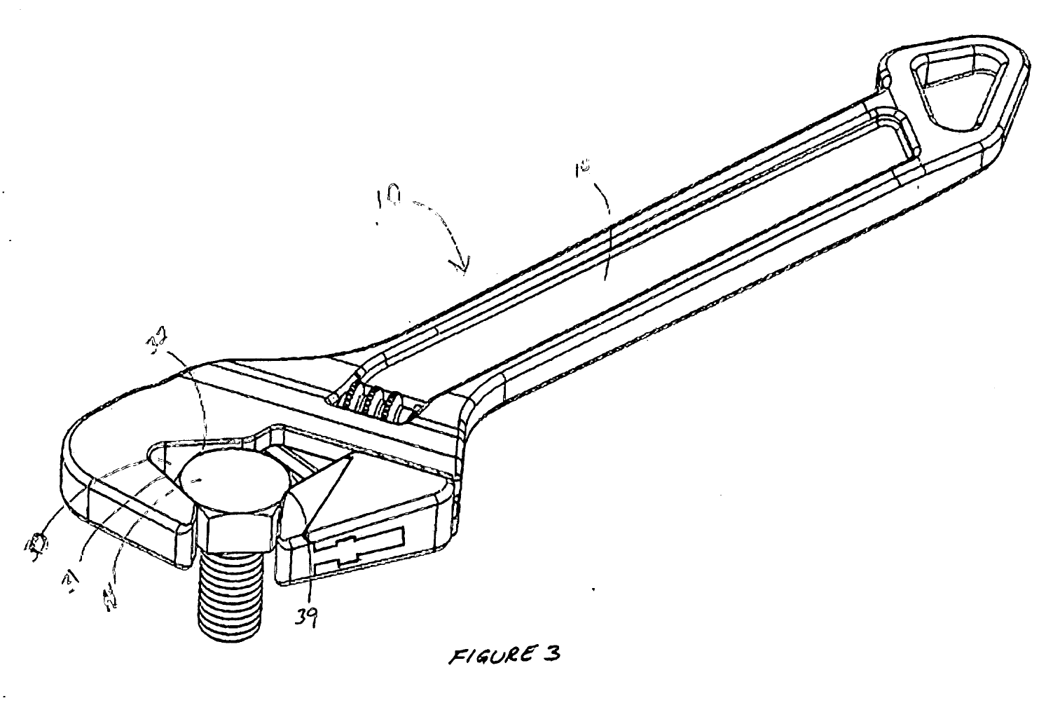

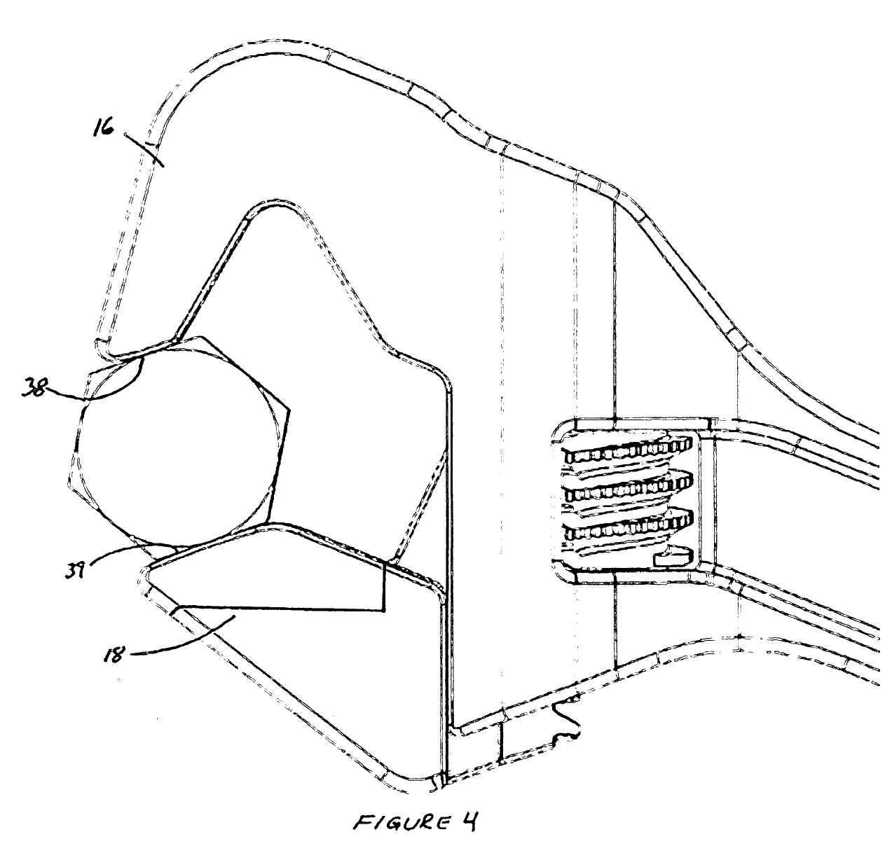

Wrench 10 may be also be used to grip hexagonal fittings in various ways. Two of these ways are shown in FIGS. 3 and 4. FIG. 3 shows wrench 1 gripping a hexagonal nut, N. The nut is received in recess 30 with two sides of the nut bearing against sides 31 and 32 of recess 30. A third side of the nut is in contact with projection 33. Nut N is therefore securely held between the jaws of wrench 10 and is prevented from rotating relative to the jaws of wrench 10 even if significant torque is applied to the nut by pulling the handle 14 of wrench 10. In the embodiment illustrated in FIG. 2, Wrench 10 engages every face of security fastener nut N. Since nut N is uniquely shaped, the faces of nut N against which wrench 10 bears are at angles of 60 degrees to one another.

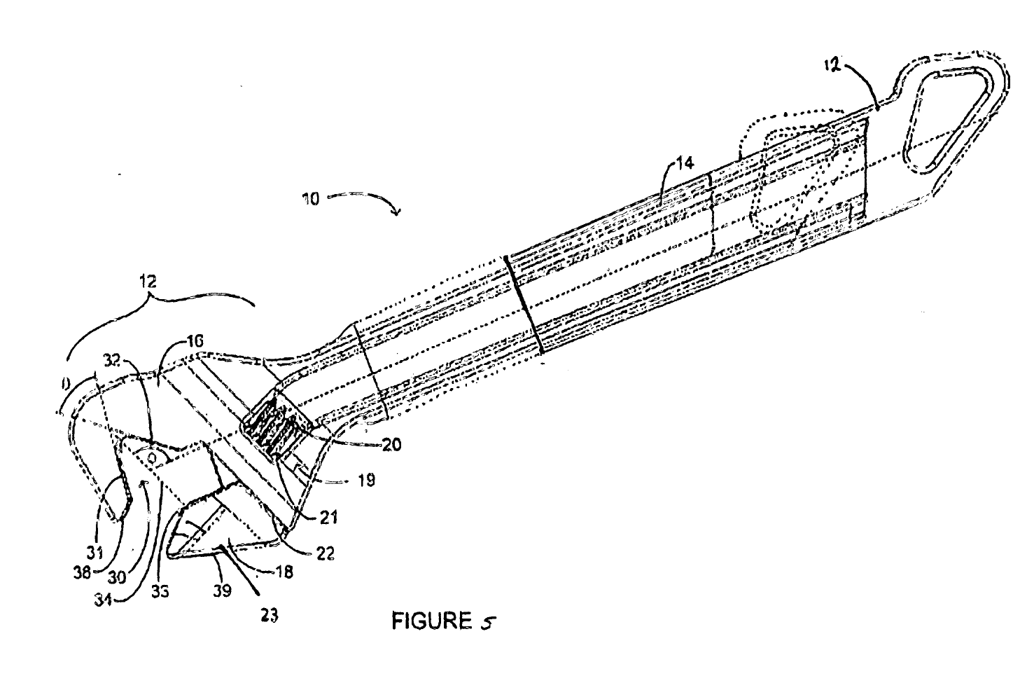

The handle configuration shown in FIG. 5 is shown as a two piece whereas the tail section 12 of the handle slides overtop of handle 14 which is fixed to the head 12 of the wrench. Handles 12 and 14 may be any suitable length when collapsed. Handle 12 can extend outward away from the fixed head to provide for additional leverage.

The jaw configuration shown in FIG. 1 is not limited to cases where V-shaped recess 30 is defined in the upper jaw, although there are advantages to providing recess 30 in the upper jaw. It is also possible to provide recess 30 on the lower jaw and to provide slidable projection 33 on the upper jaw.

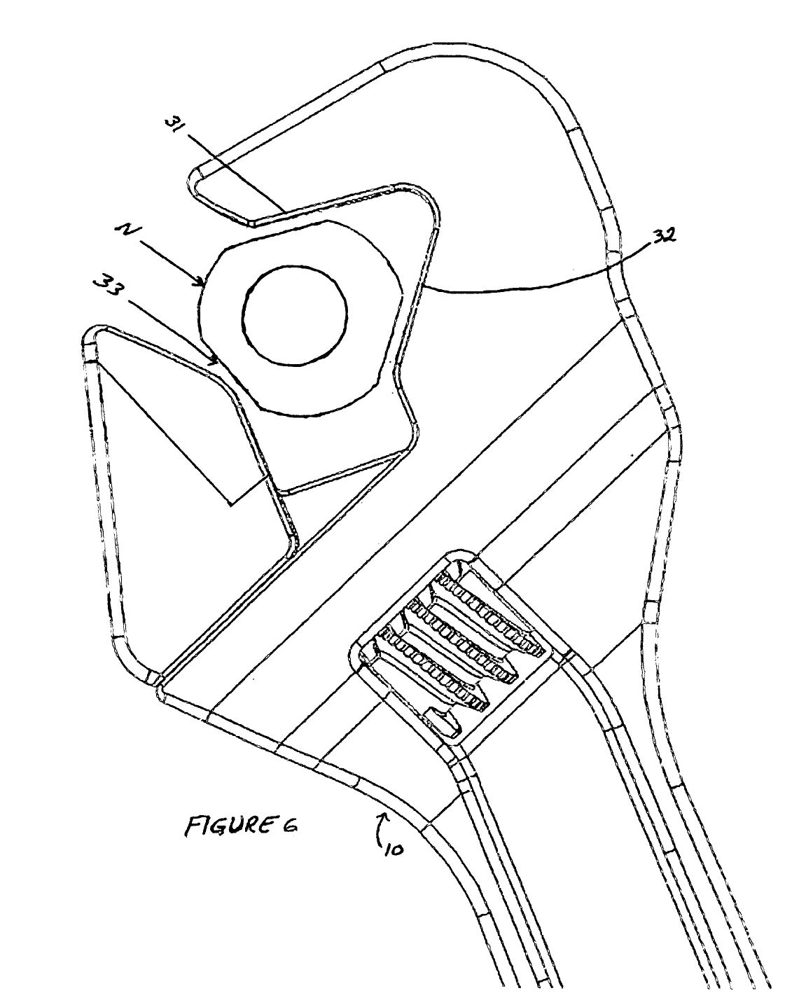

FIG. 4 shows a hexagonal nut N being gripped on two sides by the outer portion 31 of the upper jaw 16 and the outer portion of the slidable projection 39 of lower jaw 18. FIG. 6 shows a security fastener nut N positioned within the upper jaw 16 and lower jaw 18 of an open ended adjustable ratcheting type wrench 10 according to a specific embodiment to the invention.

The thickness of jaws 16 and 18 may be selected for the intended application. For heavy duty applications jaws 16 and 18 may be made thicker, whereas for applications in which fittings need to be gripped in close quarters jaws 16 and 18 may be made thinner. This also applies for the handle 14 and the tail end of the wrench 10.

A wrench like wrench 10 may have any suitable surface finish. Handle 14 may be covered with rubber, plastic or any suitable material to provide for a comfortable grip, if desired.

The jaws of wrench 10 may be made of or faced with non-marring material for use in turning fittings that are polished or have other ornamental surface treatments. Optionally a tool as described above may have jaw covers of non-marring material, such as a suitable plastic, leather, a soft metal, or the like. The jaw covers may be slipped over the jaws to cover at least portions of the jaws that contact a fitting when the jaws engage the fitting.

Wrench 10 can be of any size. Metric, Imperial or otherwise.

While a number of exemplary aspects and embodiments have been discussed above, those of skill in the art will recognize certain modifications, permutations, additions and sub-combinations as are within their true spirit and scope.

What is claimed is:

1. An open ended adjustable ratcheting wrench capable of turning specialty security fasteners with three flat edges and three rounded edges.

2. An open ended adjustable ratcheting wrench comprising of a handle, a fixed upper jaw and a movable lower jaw with a portion of the lower containing a sliding protrusion. The upper jaw having a generally V-shaped recess defined therein on a side facing toward the other of the upper and lower jaw having a protrusion thereon, the protrusion aligned with the center line of the V-shaped recess.

3. An open ended wrench according to claim 2 wherein the accessory comprises a ratchet mechanism capable of turning and ratcheting around specialty or security fasteners that have three flat sides 120 degrees from one another and three curved sides also 120. An open ended adjustable wrench according to claim 1 wherein the V-shaped recess is defined in the upper jaw and the movable protrusion is on the lower jaw.

4. An open ended adjustable ratcheting wrench according to claim 2 wherein the V-shaped recess is on the lower jaw and the moveable protrusion is on the upper jaw.

5. An open ended adjustable ratcheting wrench according to claim 2 wherein the V-shaped recess has two opposed flat sides which define an optimal angle in the range of 55 to 65 degrees.

6. An open ended adjustable ratcheting wrench according to claim 2 wherein the angle is approximately 60 degrees.

7. An open ended adjustable ratcheting wrench according to claim 2 wherein the upper and lower jaw each comprise a flattened outer portion, the flattened outer portion oriented parallel to one another.

8. An open ended adjustable ratcheting wrench according to claim 2 wherein the handle is generally straight.

9. An open ended adjustable ratcheting wrench according to claim 2 wherein the handle is curved in a direction towards the upper jaw.

10. An open ended adjustable ratcheting wrench according to claim 2 wherein the handle is curved in a direction away from the upper jaw.

11. An open ended adjustable ratcheting wrench according to claim 2 wherein the handle comprises a rigid portion connected to the jaws by a pivot joint such that the rigid portion may be pivoted out of plane of the jaws.

12. An open ended adjustable ratcheting wrench according to claim 2 wherein the handle is bent to provide an offset.

13. An open ended adjustable ratcheting wrench according to claim 2 wherein the handle is bent to extend at an angle to a plane of the jaws.

14. An open ended adjustable ratcheting wrench according to claim 2 comprising an accessory at the tail end of the handle opposite the jaws.

15. An open ended adjustable ratcheting wrench according to claim 2 wherein the accessory comprises a ratchet mechanism.

16. An open ended adjustable ratcheting wrench according to claim 2 wherein the handle is extendable.

17. An open ended adjustable ratcheting wrench according to claim 2 comprising a handle and first and second jaws coupled to a handle, one of the first and second jaws having a recess, the recess having two opposed flat sides which define an angle therebetween, and the other of the first and second jaws having a protrusion, the protrusion aligned with a center line of the recess.

18. An open ended adjustable ratcheting wrench according to claim 2 that can be turned into a non ratcheting wrench by means of a removable, replaceable moving lower jaw designed to turn specialty security fasteners with three flat edges and three rounded edges.
